(19) United States
(12) Patent Application Publication
(10) Pub. No.: US 2013/0116607 A1
(43) Pub. Date: May 9, 2013

(54) Blood Salvage Sleeve

(71) Applicant: Norman Scott Peckenpaugh, Clarkston, WA (US)

(72) Inventor: Norman Scott Peckenpaugh, Clarkston, WA (US)

(21) Appl. No.: 13/474,326

(22) Filed: May 17, 2012

Related U.S. Application Data
(60) Provisional application No. 61/556,291, filed on Nov. 7, 2011.

(51) Int. Cl. A61H 7/00

(52) U.S. Cl. 601/149

(57) ABSTRACT

A blood salvage sleeve comprises an outer surface forming a generally tubular structure with an open end and a closed end and configured for enclosing at least a portion of a patient's limb. An inner membrane is joined to the inner surface of the tubular structure. The inner membrane comprises a plurality of inflatable chambers. The inflatable chambers are disposed along a length of the tubular structure. A plurality of pressure release valves connects adjacent inflatable chambers. A plurality of one-way valves is connected to the inflatable chambers. A vent tubing conducts the released gas. An inlet tubing is connected to at least a first inflatable chamber proximate the open end, in which a pressurized gas, supplied through the inlet tubing, sequentially inflates the plurality of inflatable chambers.

### CROSS- REFERENCE TO RELATED APPLICATIONS

The present Utility patent application claims priority benefit of the [U.S. provisional application for patent serial number 61/556,291 entitled “Blood Salvage Sleeve”, filed on Nov. 7, 2011, under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to medical devices. More particularly, one or more embodiments of the invention relate to a blood salvage sleeve.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. It is believed that at present the determining factors involved in deciding if an injured limb can be reattached are often logistical. One can expect that the absence of a facility with the capability to treat severely damaged limbs near an accident victim may result in the inability to reattach the limb or the unnecessary amputation of the limb.

By way of educational background, an aspect of the prior art generally useful to be aware of is that there are currently available inflatable devices used to treat a deep vein thrombosis and devices used to stop bleeding, for example, without limitation, an inflatable tourniquet. These devices typically do not prevent loss of blood while maintaining blood flow to a damaged or severed limb.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1E illustrate an exemplary blood salvage sleeve, in accordance with an embodiment of the present invention. FIG. 1A is a cross sectional side view of the sleeve. FIG. 1B is a partially transparent perspective side view of the sleeve. FIG. 1C is a diagrammatic top view of an outer membrane of the sleeve. FIG. 1D is a diagrammatic top view of an inner membrane of the sleeve, and FIG. 1E is a diagrammatic side view of the outer membrane and the inner membrane;

FIGS. 2A and 2B illustrate an exemplary pressure relief valve, in accordance with an embodiment of the present invention. FIG. 2A is a diagrammatic side view of the valve in a closed position, and FIG. 2B is a diagrammatic side view of the valve in an open position;

FIGS. 3A and 3B illustrate an exemplary one-way valve, in accordance with an embodiment of the present invention. FIG. 3A is a diagrammatic side view of the valve in a closed position, and FIG. 3B is a diagrammatic side view of the valve in a closed position;

FIG. 4 is a diagrammatic top view of an exemplary controller in accordance with an embodiment of the present invention; and

FIG. 5 illustrates exemplary blood vessel unions for use with embodiments of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One embodiment of the present invention provides an inflatable blood salvage sleeve. In many embodiments, this sleeve is a portable device which may stop the loss of blood while generally maintaining blood flow throughout an injured or severed arm, leg, hand, or foot. Maintaining blood movement through an injured limb may enable accident victims to travel greater distances and wait longer periods of time in order to find medical attention and the limb may be more likely to be viable for surgery and possibly reattachment.

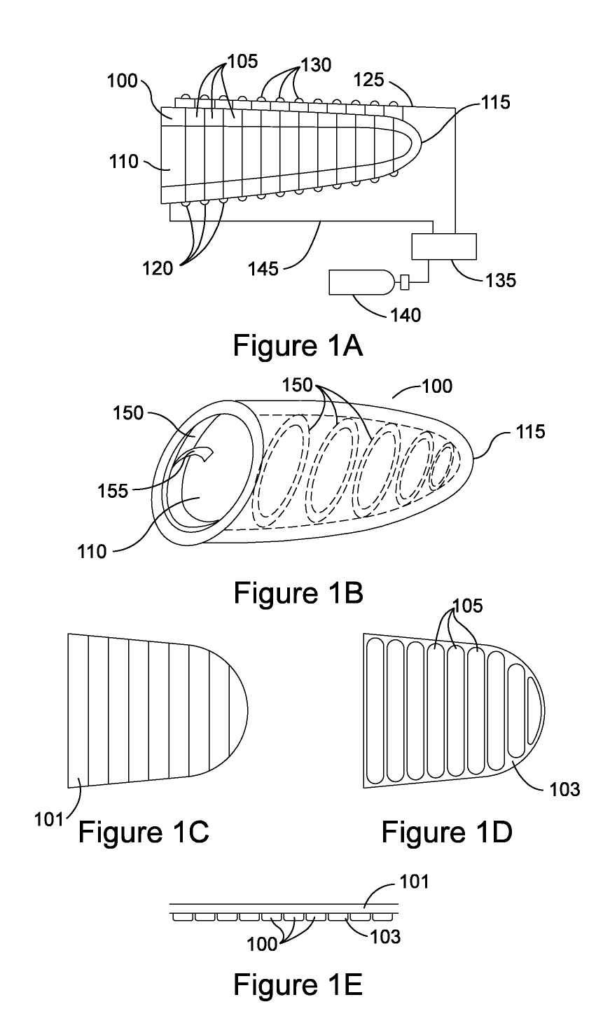

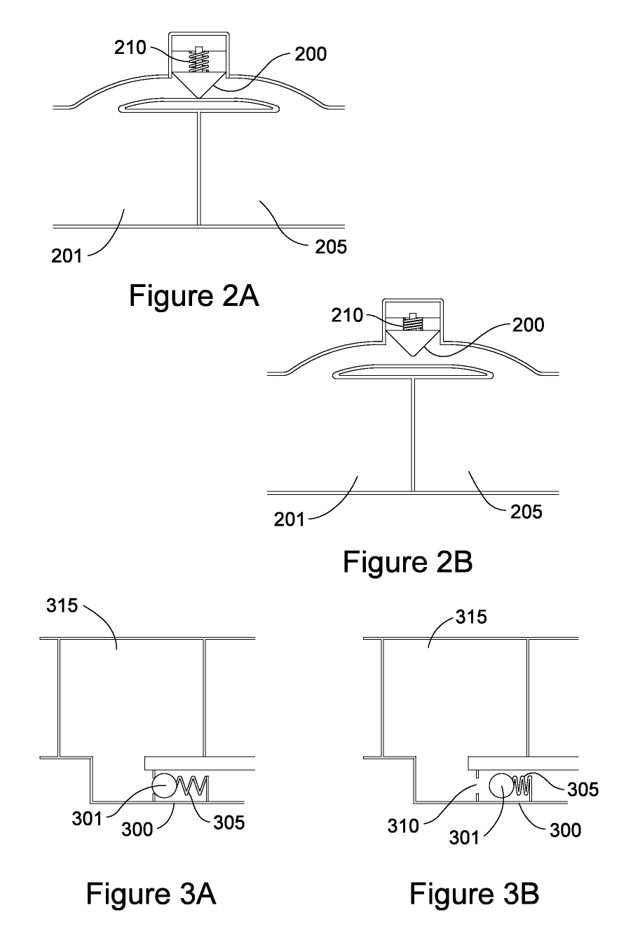

FIGS. 1A through 1E illustrate an exemplary blood salvage sleeve 100, in accordance with an embodiment of the present invention. FIG. 1A is a cross sectional side view of sleeve 100. FIG. 1B is a partially transparent perspective side view of sleeve 100. FIG. 1C is a diagrammatic top view of an outer membrane 101 of sleeve 100. FIG. 1D is a diagrammatic top view of an inner membrane 103 of sleeve 100, and FIG. 1E is a diagrammatic side view of outer membrane 101 and inner membrane 103. In the present embodiment, sleeve 100 comprises a series of inflatable chambers 105 inside a tube with an opened end 110 and a closed end 115. Referring to FIG. 1A, chambers 105 are connected to one another externally by pressure relief valves 120, as illustrated by way of example in FIGS. 2A and 2B. A vent tube 125 with multiple one-way valves 130, as illustrated by way of example in FIGS. 3A and 3B, is also connected to the series of chambers 105 with one valve 130 for each chamber 105. In the present embodiment, pressure relief valves 120 and one-way valves 130 are ball and spring type valves. It is contemplated that a multiplicity of suitable types of valves may be used in some alternate embodiments such as, but not limited to, ball valves, gate valves, globe valves, diaphragm valves, etc. Sleeve 100 may be made from a variety of different materials such as, but not limited to, various different plastics or fabrics.

In the present embodiment, vent tube 125 is connected to a controller 135, which controls the flow of gas from a pressurized gas regulator 140 into sleeve 100. Various different pressurized gasses may be used to inflate sleeve 100 including, without limitation, air, CO2, nitrogen, etc. In some alternate embodiments air pumps may be used to inflate the sleeve rather than pressurized gas. In the present embodiment, the gas enters sleeve 100 through an inlet tube 145. In some alternate embodiments, vent tube 125 and inlet tube 145 may be incorporated into the sleeve.

Referring to FIG. 1B, the interior surface of sleeve 100 comprises multiple adhesive bands 150 that may be exposed by removing plastic strips 155. It is contemplated that in some alternate embodiments, the sleeve may be implemented without adhesive sealing bands on the inside of the sleeve or with various different types of sealing means such as, but not limited to, external elastic bands or external straps. In some alternate embodiments, adhesive bands used to seal the inside of the sleeve may be provided separately and installed at the time of use. Referring to FIGS. 1C through 1E, the wall of sleeve 100 comprises outer membrane 101 and inner membrane 103. Outer membrane 101 is substantially smooth, and inner membrane 103 comprises molded chambers 105. Outer membrane 101 is a substantially flexible, non-elastic, impermeable sheet that comprises the outer surface of sleeve 100 Inner membrane 103 is a substantially flexible, elastic, impermeable sheet molded to form both the inner surface of sleeve 100 and the divisions between chambers 105. Outer membrane 101 is joined to inner membrane 103 to form chambers 105. Outer membrane 101 and inner membrane 103 may be joined by various know techniques such as, but not limited to, bonding, gluing, etc.

In typical use of the present embodiment, prior to fitting sleeve 100 to an injured limb, it is typical that the limb is temporarily fit with a tourniquet. If appropriate, the limb is given antibacterial and/or anti-clotting treatments. Sleeve 100 is placed over the distal end of the limb (e.g., over the hand or foot) and sealed around the limb with internal adhesive bands 150. The sleeve is then pulled over the proximal portion of the limb (nearer to the body) and sealed at the proximal end with adhesive bands 150. Excess air is generally purged out of the inside of sleeve 100 as it is fitted to the limb by squeezing sleeve 100. Metered pressure is then applied to sleeve 100. Once metered pressure is applied to sleeve 100, the operation of sleeve 100 is automatic. When needed, pressure is released through vent tube 125 connecting all of chambers 105 together. After the sleeve is activated the tourniquet can typically be removed. This use of sleeve 100 typically enables blood to be transferred back and forth between the body and the injured limb with little loss of blood. Sleeve 100 is generally implemented for periods of time long enough to transport a victim to a facility that can provide necessary medical attention. The limb is typically kept viable by maintaining blood flow. Some embodiments of the present invention may be used in various different settings including, without limitation, military settings, hospitals, ambulances, etc.

FIGS. 2A and 2B illustrate an exemplary pressure relief valve 200, in accordance with an embodiment of the present invention. FIG. 2A is a diagrammatic side view of valve 200 in a closed position, and FIG. 2B is a diagrammatic side view of valve 200 in an open position. In the present embodiment, when the pressure in a first chamber 201 reaches a predetermined pressure, pressure relief valve 200 between chamber 201 and a chamber 205 is forced open. The pressure required to open pressure relief valve 200 is typically determined by a preset tension of a spring 210. When pressure relief valve 200 opens, valve 200 allows gas to enter chamber 205 while maintaining pressure in chamber 201. This generally causes chamber 205 to expand.

FIGS. 3A and 3B illustrate an exemplary one-way valve 300, in accordance with an embodiment of the present invention. FIG. 3A is a diagrammatic side view of valve 300 in a closed position, and FIG. 3B is a diagrammatic side view of valve 300 in a closed position. In the present embodiment, one-way valve 300 comprises a ball 301 and a spring 305. Referring to FIG. 3A, ball 301 fits into an opening 310 when in the closed position. Referring to FIG. 3B, once the pressure inside a chamber 315 reaches a predetermined pressure, the pressure pushes ball 301 away from opening 310 to open valve 300. The operation of one-way valve 300 and subsequent one-way valves in the vent tube generally enables gas to exit a corresponding chamber and generally prevents gas from entering subsequent chambers.

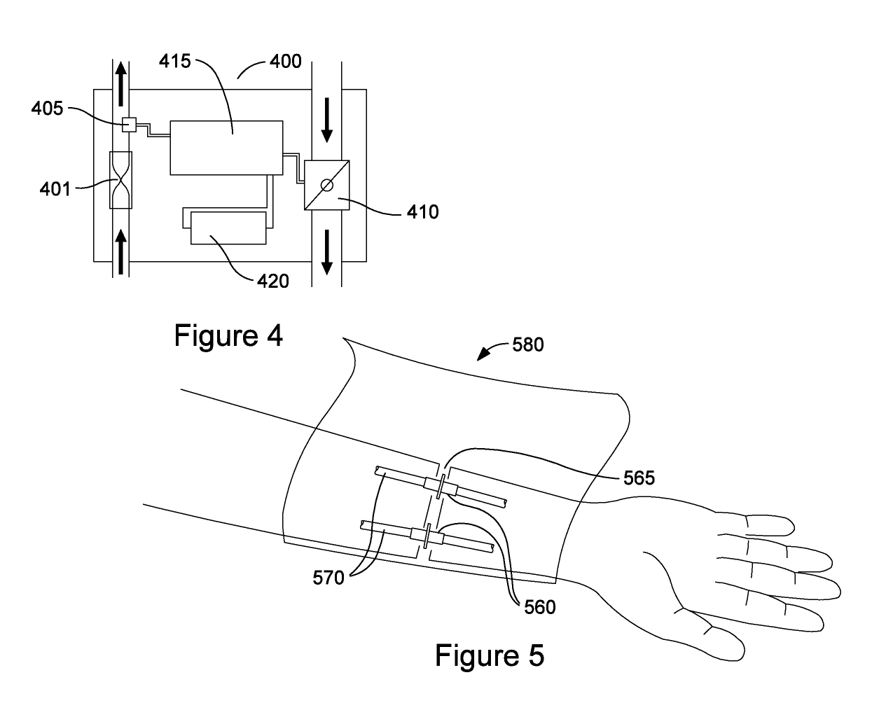

FIG. 4 is a diagrammatic top view of an exemplary controller 400 in accordance with an embodiment of the present invention. In the present embodiment, pressure from a pressurized gas regulator (P1) is factory set to a pressure slightly above normal high systolic blood pressure. In controller 400 the gas passes through a calibrated orifice 401 and past a pressure switch 405 that controls when a vent valve 410 opens to deflate the sleeve. The factory set size of calibrated orifice 401 typically determines the rate at which the sleeve inflates. As the pressure after orifice 401 (P2) fills the first chamber of the sleeve, the first chamber expands, typically stopping the flow of blood into the limb. When the pressure of the first chamber is equal to the preset pressure required to open the pressure relief valve between the first chamber and the second chamber, the pressure relief valve is forced open. When the pressure relief valve opens, gas flows into the second chamber, and the pressure relief valve generally maintains pressure in the first chamber. With the flow of gas, the second chamber expands and blood in this region of the limb is moved toward the distal end of the limb. This sequence of chamber expansion and blood movement continues toward the distal end of the sleeve through subsequent chambers. When the blood reaches the point of injury on the limb, the blood typically exits the proximal portion of the limb and reenters the distal portion of the limb. Points of entry for the blood at the distal portion of the limb may include, without limitation blood vessels, bone marrow, and tissues. Where possible, blood vessel unions may be used to encourage direct flow of blood from vessel to vessel. Exemplary blood vessel unions are shown in FIG. 5. In some implementations, the sleeve may be used without blood vessel unions. In the present embodiment, blood is generally prevented from entering the sleeve by adhesive bands inside the sleeve. Blood movement continues along the limb until blood pressure is great enough to force blood back up toward the body. As the last chamber expands deoxygenated blood is forced out of the limb. Blood follows the path of least resistance back to the body through the veins. Blood pressure prevents reentry of blood into the arteries.

Once all of the chambers are inflated, the pressure inside the chambers typically increases to a pressure greater than the pressure after orifice 401 (P2). At this point, pressure switch 405 in controller 400 signals a control circuit 415 to provide power to electronically controlled vent valve 410 and to open vent valve 410. Power is provided to the components of controller 400 by a battery 420. In some alternate embodiments, the controller may be powered by various different means such as, but not limited to, manual power, electric power from a wall outlet, solar power, etc. In the present embodiment, valve 410 is open for a brief period of time during which pressure in the chambers drops to be equal to atmospheric pressure, allowing new blood to enter the limb. When vent valve 410 is closed, pressure in the first chamber builds and the blood movement cycle is repeated. In some applications, the sleeve may be used in conjunction with blood pumps to circulate blood. Furthermore, the sleeve may be used in conjunction with intravenously injected fluids or blood. In some instances blood may be reclaimed from inside the sleeve and reintroduced into another part of the body for example, without limitation, by intravenous injection.

FIG. 5 illustrates exemplary blood vessel unions for use with embodiments of the present invention. Blood vessel unions 560 are typically soft plastic tubes that are configured fit into distal and proximal arteries and veins for connecting severed blood vessels 570. When used with embodiments of the present invention, blood vessel unions 560 provide a pathway for circulating blood to a distal end of a limb which has severed vessels. Blood vessel unions 560 may have a flange 565 at the center to prevent the blood vessel unions 560 from moving too far into blood vessels 570. Other unions may not have this flange. An impermeable adhesive coated sheet 580 may be wrapped around and adhered to the limb to maintain the position of the distal part of the limb. The adhesive coated sheet 580 may further help prevent loss of blood from vessels that are too small for unions or are too damaged to accept them.

Those skilled in the art will readily recognize, in light of and in accordance with the teachings of the present invention, that the various valves in some alternate embodiments may be operated by various different means. For example, without limitation, in some alternate embodiments, the inflation of the chambers may be cycled manually by operating a manual vent valve. In other alternate embodiments, the sleeve may be operated by electronically opened and closed valves instead of pressure operated valves. In other alternate embodiment, the sleeve may be operated by valves that are opened and closed mechanically or manually. In some alternate embodiments, electronic, mechanical or manual timers, sequencers, or controllers may be used to control the sequential inflation of the sleeve.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a blood salvage sleeve according to the present invention will be apparent to those skilled in the art. The invention has been described above by way of illustration, and the specific embodiments disclosed are not intended to limit the invention to the particular forms disclosed. For example, the particular implementation of the sleeve may vary depending upon the particular type of limb on which the sleeve is to be used. The sleeves described in the foregoing were directed to generally cylindrical implementations with one open end and one closed end; however, similar techniques are to provide sleeves of various different shapes and sizes to be used upon various different portions of the body. For example, without limitation, a sleeve with two open ends may be implemented for use on a thigh injury, or a boot shaped sleeve may be implemented for use on a foot injury. Implementations of the present invention with various different shapes and sizes are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A blood salvage sleeve comprising:
an outer surface comprising a substantially non-elastic material forming a generally tubular structure with an open end and a closed end, said outer surface being configured for enclosing at least a portion of a patient's limb;
an inner membrane structure being joined to an inner surface of said tubular structure, said inner membrane structure comprising a substantially elastic material forming a plurality of inflatable chambers, each of said inflatable chambers comprising a circumferential structure within said tubular structure, said inflatable chambers being disposed along a length of said tubular structure;
a plurality of pressure release valves connecting adjacent inflatable chambers, said pressure release valves being configured for enabling passage of a gas between chambers when a pressure of the gas exceeds a first predetermined level;
a plurality of one-way valves connected to said inflatable chambers, said on-way valves being configured for releasing gas from said inflatable chambers when a pressure of the gas exceeds a second predetermined level;
a vent tubing for conducting the released gas; and
an inlet tubing being connected to at least a first inflatable chamber proximate said open end, in which a pressurized gas, supplied through said inlet tubing, sequentially inflates said plurality of inflatable chambers.

2. The blood salvage sleeve as recited in claim 1, further comprising a plurality of sealing bands being configured for maintaining a sealing contact of said inner membrane structure with the patient's limb.

3. The blood salvage sleeve as recited in claim 2, in which said sealing bands comprise an adhesive.

4. The blood salvage sleeve as recited in claim 1, in which said non-elastic material is flexible.

5. The blood salvage sleeve as recited in claim 1, in which said outer surface and said inner membrane structure are further configured to be substantially impermeable.

6. The blood salvage sleeve as recited in claim 1, in which said pressure release valves and said one-way valves are spring operated.

7. The blood salvage sleeve as recited in claim 1, in which the gas is air.

8. A system comprising:
a blood salvage sleeve comprising:
an outer surface comprising a substantially flexible, non-elastic, impermeable material forming a generally tubular structure with an open end and a closed end, said outer surface being configured for enclosing at least a portion of a patient's limb;
an inner membrane structure being joined to an inner surface of said tubular structure, said inner membrane structure comprising a flexible, elastic, impermeable material forming a plurality of inflatable chambers, each of said inflatable chambers comprising a circumferential structure within said tubular structure, said inflatable chambers being disposed along a length of said tubular structure;
a plurality of sealing bands being configured for maintaining a sealing contact of said inner membrane structure with the patient's limb;
a plurality of pressure release valves connecting adjacent inflatable chambers, said pressure release valves being configured for enabling passage of a gas between chambers when a pressure of the gas exceeds a first predetermined level;
a plurality of one-way valves connected to said inflatable chambers, said on-way valves being configured for releasing gas from said inflatable chambers when a pressure of the gas exceeds a second predetermined level;
a vent tubing for conducting the released gas; and
an inlet tubing being connected to at least a first inflatable chamber proximate said open end, in which a pressurized gas, supplied through said inlet tubing, sequentially inflates said plurality of inflatable chambers; and
a controller comprising:
a gas inlet being configured to connect to a source of regulated pressurized gas;
an orifice being joined to said gas inlet, said orifice being configured to determine a rate of flow of the regulated pressurized gas;
a pressure switch being joined to an outlet of said orifice, said pressure switch being configured to indicate an increase in gas pressure;
a gas outlet being configured to join to said inlet tubing for supplying the flow of gas from said orifice to sequentially inflate said plurality of inflatable chambers;
a return gas inlet being configured to join to said vent tubing;
a vent valve being configured for inhibiting a flow of the released gas at least during said sequential inflation;
a controlling unit being configured for receiving a signal from said pressure switch indicating a completion of said sequential inflation, in which said controlling unit operates said vent valve for enabling a flow of the released gas at least during a period of time following said completion of said sequential inflation to deflate said plurality of inflatable chambers.

9. The system as recited in claim 8, further comprising a battery source for supplying power to at least said controlling unit, said pressure switch and said vent valve.

10. The system as recited in claim 8, further comprising a pressurized gas regulator being configured for regulating the gas input to said gas inlet.

11. The system as recited in claim 8, further comprising blood vessel unions being configured for joining severed blood vessels.

12. The system as recited in claim 8, in which said orifice is calibrated for a determined rate of said sequential inflation.

13. The system as recited in claim 8, in which said controlling unit is configured for operating said vent valve for inhibiting a flow of the released gas following said period of time to repeat said sequential inflation.

14. The system as recited in claim 8, in which said sealing bands comprise an adhesive.

15. The system as recited in claim 8, in which said pressure release valves and said one-way valves are spring operated.

16. The system as recited in claim 8, in which the gas is air.

17. A method for operating a blood salvage sleeve, the method comprising the steps of:
regulating a source of pressurized gas;
constricting a rate of flow of the pressurized gas;
monitoring a pressure of the constricted flow of gas into a blood salvage sleeve comprising a plurality of inflatable chambers being interconnected with a plurality of pressure release valves configured for sequentially inflating of the inflatable chambers in response to the constricted flow of gas, and a plurality of one-way valves configured for releasing pressure in the inflatable chambers into a vent tubing;
detecting a completion of the sequentially inflating by an indication of an increase in pressure from said monitoring; and
operating a vent valve for enabling a flow from the vent tubing to deflate the inflatable chambers upon said detecting.

18. The method as recited in claim 17, further comprising the step of operating the vent valve to inhibit the flow from the vent tubing to repeat a sequential inflating of the inflatable chambers.

19. The method as recited in claim 17, in which said monitoring further comprises monitoring a pressure switch for the increase in pressure.

20. The method as recited in claim 17, in which said constricting further comprises using an orifice.
